(19) United States
(12) Patent Application Publication
(10) Pub. No.: US 2003/0120815 A1
(43) Pub. Date: Jun. 26, 2003

(54) System and method of real-time interaction for multiple objects

(76) Inventors: Yu-Jung Cheng, Elen Hsien (TW); Yu-Sheng Weng, Taipei Hsien (TW); Chin-Wei Chang, TaiChung Hsien (TW)

Correspondence Address: MERCHANT & GOULD PC, P.O. BOX 2903, MINNEAPOLIS, MN, 55402-0903, US

(21) Appl. No.: 10/075,820

(22) Filed: Feb. 12, 2002

(30) Foreign Application Priority Data
Dec. 21, 2001 (TW) 90131395

(51) Int. Cl. G06F 9/46; G06F 15/16; G06F 15/173; G06F 9/00

(52) U.S. Cl. 709/248; 709/225; 709/316; 709/204

(57) ABSTRACT

A system of real-time interaction for multiple objects. The system includes a scene dividing module, a first control unit, a second control unit, and a synchronization module. The scene dividing module divides a main scene into a first scene and a second scene, and determines the adjacent area of the first scene and the second scene. The first control unit controls at least one object in the first scene, and the second control unit controls at least one object in the second scene. When the status incidence of the objects controlled by the first control unit and/or the second control unit overlaps the adjacent area of the first scene and the second scene, the synchronization module enables the first control unit to synchronize with the second control unit.

### BACKGROUND OF THE INVENTION

1. Field of the Invention

The present invention relates to a system and method of real-time interaction for multiple objects, and particularly to a system and method of real-time interaction for multiple objects that employs multiple servers to control respective scenes and synchronizes between these servers only as necessary, so as to balance the loads on these servers and reduce the costs of communication between them.

2. Description of the Related Art

In conventional system of real-time interaction for multiple objects (the system also can be called a multi-user real-time interaction system), system messages are communicated via client/server architecture. In current multi-user real-time interaction system, such as online games, a single server is always employed to control a single scene.

FIG. 1 shows an example of a multi-user real-time interaction system with client/server architecture. In this system, three scenes (20, 21, and 22) are controlled by three servers (10, 11, and 12) respectively. Each of the servers (10, 11, and 12) can be composed of several server programs, and provide service to the clients (30, 31, and 32) accessing the scenes (20, 21, and 22) respectively. In such systems, it is easy to construct and maintain the system, however, the expansibility of the system is limited and the function of dynamic expansion and fault tolerance will be hard to achieve.

In order to overcome these drawbacks and further provide the function of dynamic expansion and fault tolerance conventionally, multiple servers are employed to control one scene. In FIG. 2, scene 20 is controlled by three servers 10, and each of the servers 10 can provide service to the clients 30 accessing the scene 20, and scene 21 is controlled by three servers 11, and each of the servers 11 can provide service to the clients 31 accessing the scene 21.

A system employing multiple servers to control one scene can solve the drawbacks of the system in FIG. 1, however, a large amount of communication between servers for synchronizing the scenes reducing the efficiency of the system.

### SUMMARY OF THE INVENTION

It is therefore an object of the present invention to provide a system and method of real-time interaction for multiple objects that employs multiple servers to control respective scenes, so as to balance loads on these servers, and synchronizes between these servers only as necessary, so as to reduce the costs of communication between them.

To achieve the above objects, the present invention provides a system and method of real-time interaction for multiple objects. According to the embodiment of the invention, the system of real-time interaction for multiple objects includes a scene dividing module, a first control unit, a second control unit, and a synchronization module.

The scene dividing module divides a main scene into a first scene and a second scene, and determines the adjacent area of the first scene and the second scene. The first control unit controls at least one object in the first scene, and the second control unit controls at least one object in the second scene. When the status incidence of the objects controlled by the first control unit and/or the second control unit overlaps the adjacent area of the first scene and the second scene, the synchronization module enables the first control unit to synchronize with the second control unit.

According to the embodiment of the invention, the method of real-time interaction for multiple objects, first, a main scene is divided into a first scene and a second scene, and the adjacent area of the first scene and the second scene is determined. Then, at least one object in the first scene is controlled by a first control unit, and at least one object in the second scene is controlled by a second control unit. Finally, the first control unit is synchronized with the second control unit if the status incidence of the objects controlled by the first control unit and/or the second control unit overlaps the adjacent area of the first scene and the second scene.

In addition, the scene dividing module further divides the first scene into a first sub-scene and a second sub-scene if the number of objects controlled by the first control unit is more than a load threshold, and then the objects in the first sub-scene are controlled by the first control unit, and the objects in the second sub-scene are controlled by a third control unit.

Further, the scene dividing module divides the main scene into the first scene and the second scene according to the potential visible set (PSV) and grid.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram showing the system structure of a multi-user real-time interaction system with client/server architecture;

FIG. 2 is a schematic diagram showing the system structure of a multi-user real-time interaction system that employs multiple servers to control one scene;

FIG. 3 is a schematic diagram showing the system structure of a system of real-time interaction for multiple objects according to the embodiment of the present invention;

FIG. 4 is a schematic diagram showing the synchronization process between control units;

FIG. 5a shows the rooms of an indoor scene;

FIG. 5b shows indoor scenes in FIG. 5a with grids;

FIG. 5c shows the result of further dividing indoor scenes in FIG. 5b;

FIG. 6 shows the scene structure of indoor scenes after dividing;

FIG. 7a shows a outdoor scene;

FIG. 7b shows outdoor scenes in FIG. 7a with grids;

FIG. 7c shows the result of dividing outdoor scenes in FIG. 7b; and

FIG. 8 is a flow chart illustrating the operation of a method of real-time interaction for multiple objects according to the embodiment of the present invention.

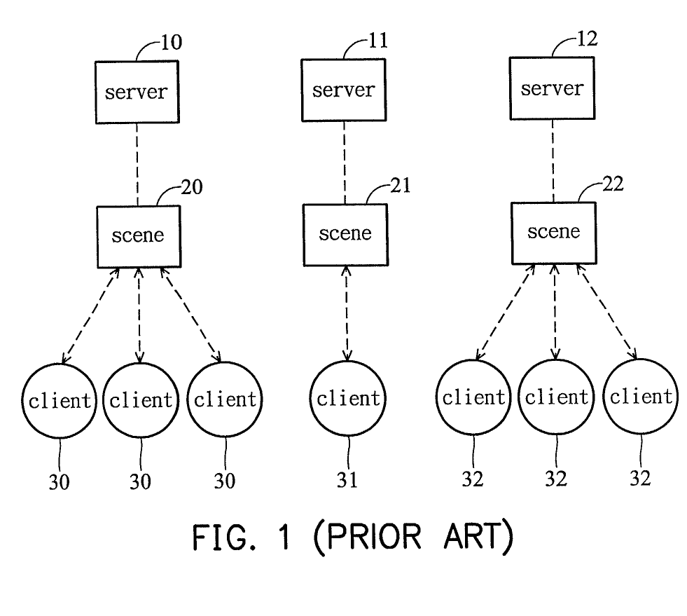

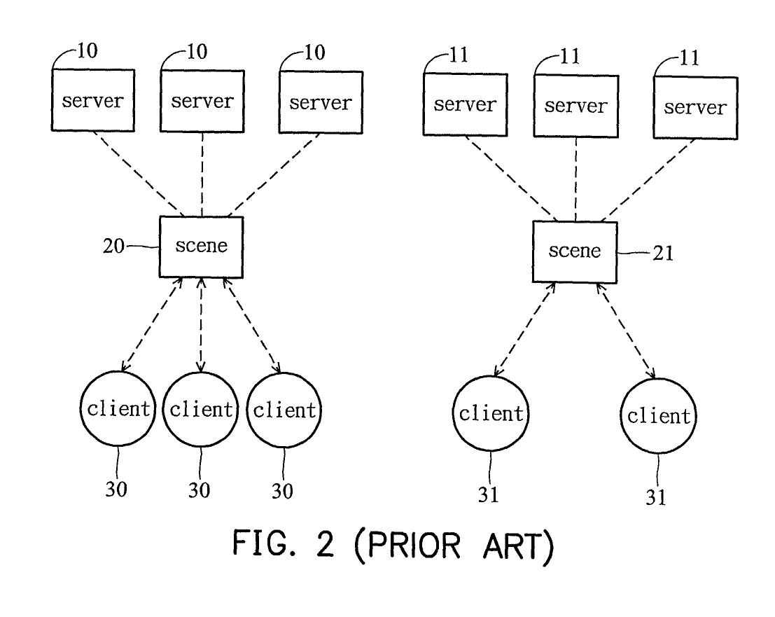

### DETAILED DESCRIPTION OF THE PREFERRED EMBODIMENT

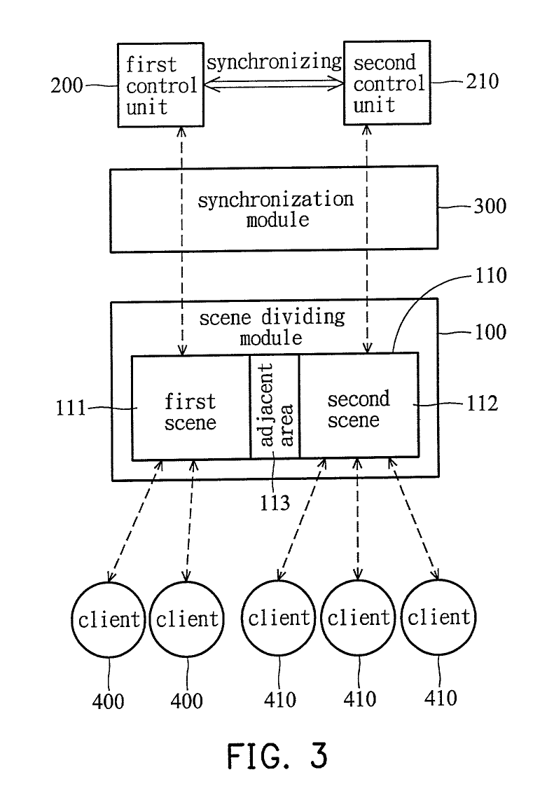

FIG. 3 shows the system structure of a system of real-time interaction for multiple objects according to the embodiment of the present invention. Referring to FIG. 3, the system provides real-time interaction for multiple users (clients 400, and 410), the system includes a scene dividing module 100, a first control unit 200, a second control unit 210, and a synchronization module 300.

The scene dividing module 100 divides a main scene 110 into a first scene 111 and a second scene 112, and determines the adjacent area 113 of the first scene 111 and the second scene 112. It should be noted that the scene dividing module 100 divides the main scene 110 into the first scene 111 and the second scene 112 according to the potential visible set (PSV) and grid, and the dividing method will be discussed later.

The first control unit 200 controls the objects (not shown) corresponding to the clients 400 in the first scene 111, and the second control unit 210 controls the objects (not shown) corresponding to the clients 410 in the second scene 112. The first control unit 200 and the second control unit 210 may be server programs or groups of several server programs, and the first control unit 200 and the second control unit 210 are responsible for handling the behavior of respective objects, the states of the scenes, the interaction between objects, and the events produced by the scene, such as event trigger, event close, and the status of events.

When the status incidence of the objects controlled by the first control unit 200 and/or the second control unit 210 overlaps the adjacent area 113 of the first scene 111 and the second scene 112, the synchronization module 300 enables the first control unit 200 to synchronize with the second control unit 210. The synchronization process includes exchanging the information of the behavior of respective objects, the states of the scenes, the interaction between objects, and the events produced by respective scenes, such as event trigger, event close, and the status of events between two control units.

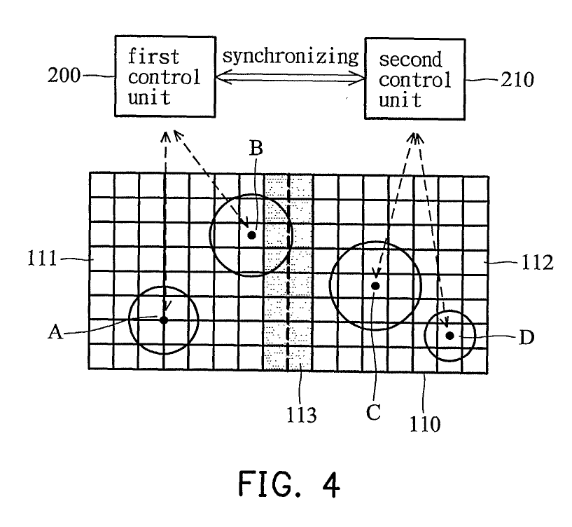

It should be noted that the status incidence represents the range that can be affected by the behavior of an object. FIG. 4 shows the synchronization process between control units. In FIG. 4, there are four objects (A, B, C, and D) in the main scene 110. Object A and object B are positioned in the first scene 111, and controlled by the first control unit 200. Object C and object D are positioned in the second scene 112, and controlled by the second control unit 210. In FIG. 4, the status incidence of the object can be denoted by a circle in plane.

In this case, object B is in the first scene 111, however, the status incidence of object B overlaps the adjacent area 113, which means the behavior of object B may affect the second scene 112. The synchronization module will detect this situation (the status incidence of object B and the adjacent area 113 are overlapped), and then enable the first control unit 200 and second control unit to synchronize. If object B moves to the second scene 112, object B will be taken over by the second control unit 210.

Further, the scene dividing module 100 further divides the first scene 111 into a first sub-scene (not shown) and a second sub-scene (not shown) if the number of objects controlled by the first control unit 200 is more than a load threshold, the objects in the first sub-scene are controlled by the first control unit 200, and the objects in the second sub-scene are taken over by a third control unit (not shown), so as to maintain load balance of the entire system. In addition, if a failure occurs in the first control unit 200 or the first control unit 200 is suspended, the first scene 111 and objects controlled by the first control unit 200 can be taken over by another control unit. In one aspect, the third control unit can be set as the control unit that controls the scene adjacent to the scene controlled by the failure control unit.

It should be noted that the connection relation between control units may be determined according to the adjacent relation between scenes. The control units that control adjacent scenes may connect as a peer to peer structure or a multicast group structure.

The dividing method that employs the potential visible set (PSV) and grid is described as follows.

A virtual world (scene) always includes indoor and outdoor scenes. Indoor scenes may be composed of several rooms or closed regions, the visible relation between adjacent rooms can be acquired according to the position of these rooms, and the visible relation can be used as the connection relation of these rooms. Outdoor scenes may be considered as an open 3D scene, users can freely move in these scenes, and the visible range is more broad. According to the embodiment, the dividing methods for indoor scenes and outdoor scenes may be different, described as follows.

Indoor Scene

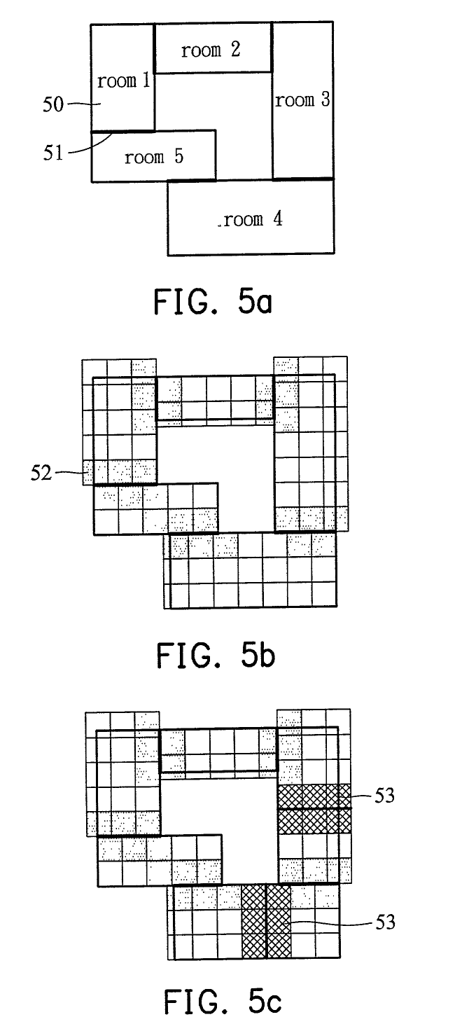

FIG. 5a shows the rooms 50 of an indoor scene, the broad line represents the portal 51 of the room 50. In the embodiment, indoor scenes can be defined as a main scene in level 1, and each of the rooms 50 can be defined as level 2 scenes, such as the first scene and the second scene described above. Further, each of the rooms 50 may be divided into sub-scenes in the next level.

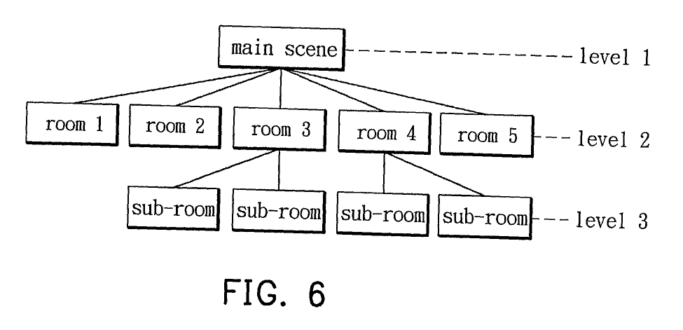

Before dividing the rooms 50 into sub-scenes, in order to determine the adjacent area of scenes, grids are added to indoor scenes in FIG. 5a. FIG. 5b shows indoor scenes with grids, and the gray grids represent the adjacent areas 52. Next, since the area of room 3 and room 4 is larger than the other rooms, room 3 and room 4 can be further divided into two sub-rooms, and the adjacent area 53 of sub-rooms also can be acquired, as shown in FIG. 5c. The entire scene structure of indoor scenes can be represented as FIG. 6.

Outdoor Scene

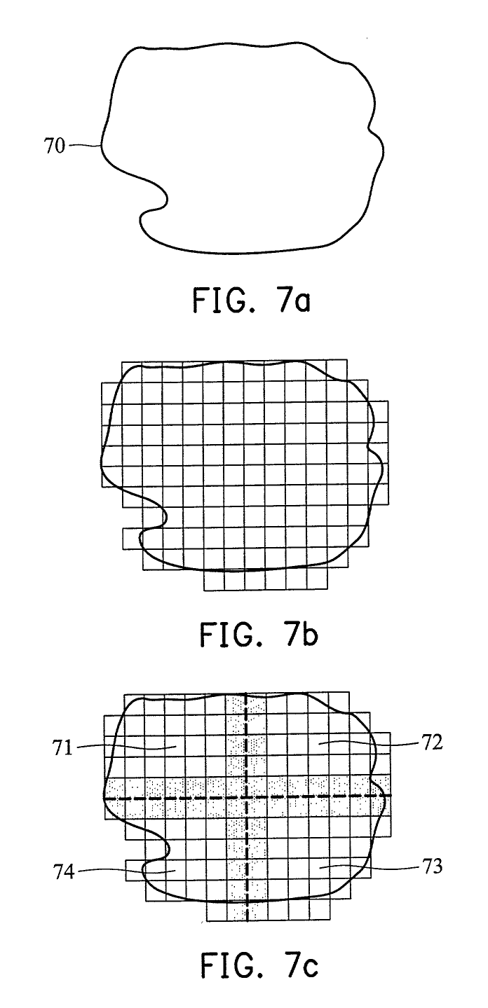

For simple description, outdoor scenes is discussed in 2D. As an example, outdoor scenes 70 is shown in FIG. 7a, and the range covered by outdoor scenes can be determined by adding grids to outdoor scenes 70, as shown in FIG. 7b.

Then, outdoor scenes 70 can be divided according to the coverage relation between grids and outdoor scenes 70 and the maximum bounding box. In this case, since the maximum bounding box is similar to a square or a rectangle, outdoor scenes 70 can be dividedinto four scenes (71, 72, 73, and 74), and the adjacent area of these scenes also can be acquired, as shown in FIG. 7c. The dividing method for each of the scenes (71, 72, 73, and 74) is omitted, since it is similar to the indoor scene. In addition, if outdoor scenes is an irregular shape, the divided scene can be combined with its adjacent scene according to its area, so as to average the area of scene controlled by each of the control units.

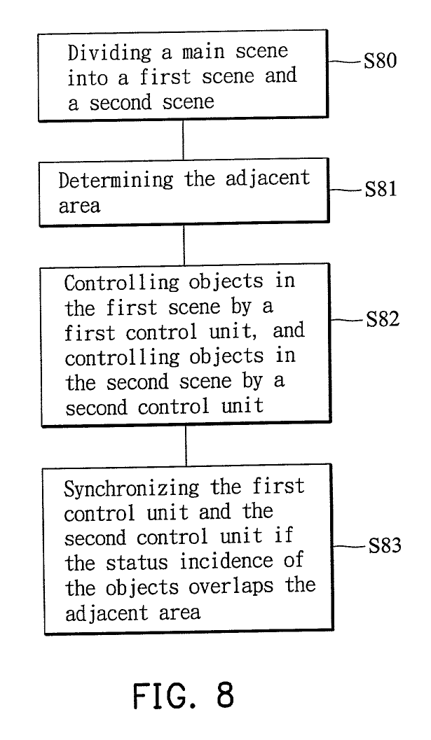

Next, FIG. 8 shows the operation of a method of real-time interaction for multiple objects according to the embodiment of the present invention.

First, in step S80, a main scene 110 is divided into a first scene 111 and a second scene 112, and in step S81, the adjacent area 113 of the first scene 111 and the second scene 112 is determined. Then, in step S82, the objects in the first scene 111 are controlled by a first control unit 200, and the objects in the second scene 112 are controlled by a second control unit 210. Similarly, the first control unit 200 and the second control unit 210 may be server programs or groups of several server programs, and the first control unit 200 and the second control unit 210 are responsible for handling the behavior of respective objects, the states of the scenes, the interaction between objects, and the events produced by the scene, such as event trigger, event close, and the status of events.

Finally, in step S83, the first control unit 200 is synchronized with the second control unit 210 if the status incidence of the objects controlled by the first control unit 200 and/or the second control unit 210 overlap the adjacent area 113 of the first scene 111 and the second scene 112. Similarly, the synchronization process includes exchanging the information of the behavior of respective objects, the states of the scenes, the interaction between objects, and the events produced by respective scenes, such as event trigger, event close, and the status of events between two control units.

Further, the first scene 111 can be further divided into a first sub-scene and a second sub-scene if the number of objects controlled by the first control unit 200 is more than a load threshold, and then the objects in the first sub-scene are controlled by the first control unit 200, and the objects in the second sub-scene are taken over by a third control unit. Furthermore, if a failure occurs in the first control unit 200 or the first control unit 200 is suspended, the first scene 111 and objects controlled by the first control unit 200 can be taken over by another control unit.

According to the embodiment, each of the scenes and the corresponding control unit can be clearly determined according to the scene structure. The distribution of scene is from level 1, if the main scene needs to be controlled by more control units, the scene distributed to each of the control units can be determined according to the scenes in level 2 of the scene structure.

As a result, using the system and method of real-time interaction for multiple objects according to the present invention can employ multiple servers to control respective scenes, so as to balance the loads in these servers, and synchronize between these servers only as necessary, so as to reduce the costs of communication between them.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system of real-time interaction for multiple objects, comprising:
a scene dividing module for dividing a main scene into a first scene and a second scene, and determining the adjacent area of the first scene and the second scene;
a first control unit for controlling at least one object in the first scene;
a second control unit for controlling at least one object in the second scene; and
a synchronization module to enable the first control unit to synchronize with the second control unit if the status incidence of the objects controlled by the first control unit and/or the second control unit overlaps the adjacent area of the first scene and the second scene.

2. The system as claimed in claim 1 wherein the scene dividing module further divides the first scene into a first sub-scene and a second sub-scene if the number of objects controlled by the first control unit is more than a load threshold.

3. The system as claimed in claim 2 wherein the objects in the first sub-scene are controlled by the first control unit, and the objects in the second sub-scene are controlled by a third control unit.

4. The system as claimed in claim 1 wherein the objects controlled by the first control unit are taken over by a third control unit if a failure occurs in the first control unit.

5. The system as claimed in claim 1 wherein the scene dividing module divides the main scene into the first scene and the second scene according to the potential visible set and grid.

6. The system as claimed in claim 1 wherein the first control unit and/or the second control unit are responsible for handling the behavior of objects.

7. The system as claimed in claim 1 wherein the first control unit and/or the second control unit are responsible for handling the interaction between objects.

8. The system as claimed in claim 1 wherein the first control unit and/or the second control unit are responsible for handling the events produced by scenes.

9. An method of real-time interaction for multiple objects, comprising the steps of:
dividing a main scene into a first scene and a second scene, and determining the adjacent area of the first scene and the second scene;
controlling at least one object in the first scene by a first control unit, and at least one object in the second scene by a second control unit; and
synchronizing the first control unit with the second control unit if the status incidence of the objects controlled by the first control unit and/or the second control unit overlaps the adjacent area of the first scene and the second scene.

10. The method as claimed in claim 9 further dividing the first scene into a first sub-scene and a second sub-scene if the number of objects controlled by the first control unit is more than a load threshold.

11. The method as claimed in claim 10 further comprising controlling the objects in the first sub-scene by the first control unit, and the objects in the second sub-scene by a third control unit.

12. The method as claimed in claim 9 further comprising taking over the objects controlled by the first control unit by a third control unit if a failure occurs in the first control unit.

13. The method as claimed in claim 9 wherein the main scene is divided into the first scene and the second scene according to the potential visible set and grid.

14. The method as claimed in claim 9 wherein the first control unit and/or the second control unit are responsible for handling the behavior of objects.

15. The method as claimed in claim 9 wherein the first control unit and/or the second control unit are responsible for handling the interaction between objects.

16. The method as claimed in claim 9 wherein the first control unit and/or the second control unit are responsible for handling the events produced by scenes.
